(19) United States
(12) Patent Application Publication
(10) Pub. No.: US 2009/0013469 A1
(43) Pub. Date: Jan. 15, 2009

(54) BED ATTACHMENT FOR PREVENTING AND TREATING DECUBITUS ULCERS

(76) Inventor: Annamae A. Johnson, Roseburg, OR (US)

Correspondence Address: AVERY ENTERPRISES, BOX 238, JOHNSTOWN, CO, 80534, US

(21) Appl. No.: 11/778,037

(22) Filed: Jul. 14, 2007

(51) Int. Cl. A61G 7/008; A61G 7/10

(52) U.S. Cl. 5/612; 5/607

(57) ABSTRACT

Disclosed is a device that attaches to a standard bed and prevents or treats bedsores by using electro-mechanical means to rotate a person from side to side in a bed without human assistance. In one embodiment, a controller that is attached to at least one linear actuator and at least one electric motor is used to rotate a person in bed at regular intervals without human assistance and without disturbing any medical equipment to which the person may be attached.

### BACKGROUND OF THE INVENTION

a. Field of the Invention

The present invention generally pertains to beds and more particularly to devices that attach to a bed and rotate a person in a bed to prevent a person from developing decubitus ulcers or treat a person's existing decubitus ulcers.

b. Description of the Background

Persons who must spend extended periods of time in bed are prone to develop decubitus ulcers. Often called “pressure ulcers” or “bedsores”, decubitus ulcers occur over the bony prominences and weight-bearing surfaces of immobile persons. Inadequate air circulation and constant pressure interrupts blood flow, which may result in tissue damage. It is possible to prevent and treat bedsores by providing appropriate padding and turning an immobile person on a regular schedule. Immobile persons who are not turned regularly (as is the case in many health-care facilities because of inadequate staffing) are at high risk for developing bedsores, which are typically slow to heal and quick to become infected. Such movement of immobile persons often causes injury to health-care workers, who typically use their own brute strength (either alone or with other workers) to move a person (especially a morbidly obese person) into a new position in bed. This is one reason why, although general medical practice recommends that a person be rotated from one position in bed to another position in bed about every 2 hours to prevent and treat bedsores, many care facilities and private homes do not reach this standard (turning their patients less often).

Some methods of effecting movement and some devices that allow such movement strategically place straps, connectors, pull or rotator sheets, air bags or pillows under various sections of a person's body (after the person has been moved by brute strength) to help keep all the person's body sections (head, torso, legs, etc.) in their new positions. These may cause friction, which can cause shearing of a person's skin (especially an elderly person's skin) when a person is pulled across a sheet during transferring and repositioning. The pure brute strength required to use such devices can cause injury to those who must rotate a person in bed.

Non-standard bed styles have been developed to help rotate bedridden persons. U.S. Pat. No. 4,578,833 (Vrzalik) discloses a therapeutic bed that, among other features, can be rotated from side to side—provided a person in bed uses its fasteners to keep himself in place during rotation. U.S. Pat. No. 5,625,913 (Singleton) discloses a bed built like a cradle that can be rotated either by an electric motor or manually with a brake. Such non-standard bed styles cannot interface with a standard bed in a health-care facility; to employ such a device would require complete replacement of a bed, great expense, and great logistical effort if employed in large quantities at a typical health-care facility.

Standard-style beds that rotate a person from side to side in bed typically require human assistance at some point during the rotation process. U.S. Pat. No. 5,054,140 (Bingham and Brown) includes both a hand and a foot actuator that must be used by another person whenever the device is in operation. The patent WO 96/027356 (Connolly and Keenan) discloses a drive belt to rotate a bed from side to side by a “scissors” motion but cannot be operated automatically. U.S. Pat. No. 5,640,729 (Marino) discloses a bed that can be rotated from side to side but lacks a means to automatically control its movement; human intervention is required to regularly rotate a person in bed.

U.S. Pat. No. 5,659,905 (Palmer) discloses a device with a bed and two booms, one along each side of the bed. The booms have articulating arms that control pull sheets under a person in bed; when the booms are activated, the articulating arms raise to their full height and move the pull sheets, causing a person in bed to be rotated. The Palmer device, however, can lift a person out of bed and can be operated by the person in bed. These features are not always desirable or necessary, especially for a person with Alzheimer's disease who can't understand why he is being lifted out of bed but may suddenly feel that he is falling.

Some devices that allow rotation of a person in bed attach to standard-sized beds. U.S. Pat. No. 4,225,988 (Cary, et al.) discloses a cable and actuator system that allows a bed to be set at an angled position to hold a person in a rotated position. However, to move a person into a new angled position again requires human intervention to adjust the cable and actuator system. U.S. Pat. No. 5,410,768 (Manson, et al.) discloses a device that attaches to a bed and rocks the bed for a period of time by hydraulically raising and lowering the legs of the bed. But attaching such a device can be time-consuming and require the services of an experienced mechanic to ensure the device functions properly.

It would therefore be advantageous to have a device for preventing and treating bedsores that easily attaches to a bed and does not require expert installation. It would also be advantageous if such a device used electro-mechanical means to rotate a person from side to side in a bed to prevent and treat bedsores without requiring another person to be involved. It would be further advantageous if such a device included a controller that would allow a person to be rotated at regular intervals (such as in the middle of the night) without requiring another person to be present.

### SUMMARY OF THE INVENTION

The present invention overcomes the disadvantages and limitations of the prior art by providing a device that attaches to a standard bed (such as in a typical health-care facility) and prevents and treats bedsores by using electro-mechanical means to rotate a person from side to side in a bed without human assistance. In one embodiment, a controller is attached to at least one electric motor and allows a person to be rotated in the bed at regular intervals without another person being present.

The present invention may therefore comprise a device that attaches to a bed frame by at least one fastener and allows rotation of a person from side to side in a bed without human assistance, comprising: a headboard assembly, a footboard assembly, a set of railings, an adjustable sling containing at least one layer of washable material that is detachable from the device, attaches by a set of fasteners to the set of railings, supports the weight of a person, and whose movement while fastened to the set of railings creates a rotation of a person, and a controller (such as a programmable logic controller or at least one electro-mechanical switch) that controls the movement of the device. The device may attach to a standard twin-size bed frame or standard hospital bed frame by replacing a footboard, a headboard and/or two railings of the standard twin-size bed frame or standard hospital bed frame with the device. The headboard and footboard assemblies and the set of railings may be made of a metal, a metallic compound (such as steel) or a composite material. The headboard and footboard assemblies may comprise: a headboard or footboard, a linear actuator, an electro-mechanical apparatus (such as an electric motor) that controls the linear actuator, two swing arms that connect to and control the movement of the set of railings, and a drive plate that moves the swing arms and is moved by the linear actuator. The device may further comprise an adjustable pressure-relieving pad containing at least one layer of absorbent material that fits between a person in a bed and the adjustable sling. This pad may be adjusted by at least one fastener to allow the pad to be attached to the adjustable sling.

The present invention may further comprise a method of rotating a person from side to side in a bed at regular intervals without human assistance, comprising: removing a footboard, a headboard and/or two railings of a standard twin-size bed frame or standard hospital bed frame, attaching a device to a standard twin-size bed frame or standard hospital bed frame that can rotate a person without human assistance and without disturbing any medical equipment to which the person may be attached, and activating the device. The device may comprise: a headboard assembly, a footboard assembly, a set of railings, an adjustable sling containing at least one layer of washable material that is detachable from the device, attaches by a set of fasteners to the set of railings, supports the weight of a person, and whose movement while fastened to the set of railings creates a rotation of a person, and a controller (such as a programmable logic controller or at least one electro-mechanical switch) that controls the movement of the device. The headboard and footboard assemblies may comprise: a headboard or footboard, a linear actuator, an electro-mechanical apparatus (such as an electric motor) that controls the linear actuator, two swing arms that connect to and control the movement of the set of railings, and a drive plate that moves the swing arms and is moved by the linear actuator. The device may further comprise an adjustable pressure-relieving pad containing at least one layer of absorbent material that fits between a person in a bed and the adjustable sling.

The main advantage of the present invention is that it attaches to (instead of replacing entirely) a standard bed and allows prevention and treatment of bedsores by rotating a person in bed without human assistance. A person may be rotated in bed using the present invention without disturbing medical equipment to which the person may be attached (tubes, IV poles, catheters, etc.)

### BRIEF DESCRIPTION OF THE DRAWINGS

In the drawings,

FIG. 1 is a perspective view of one embodiment of the underlying frame of the present invention.

FIG. 2 illustrates one embodiment of a headboard or footboard assembly of the present invention.

FIG. 3 is a perspective view of the present invention as used to rotate a person in a bed.

### DETAILED DESCRIPTION OF THE INVENTION

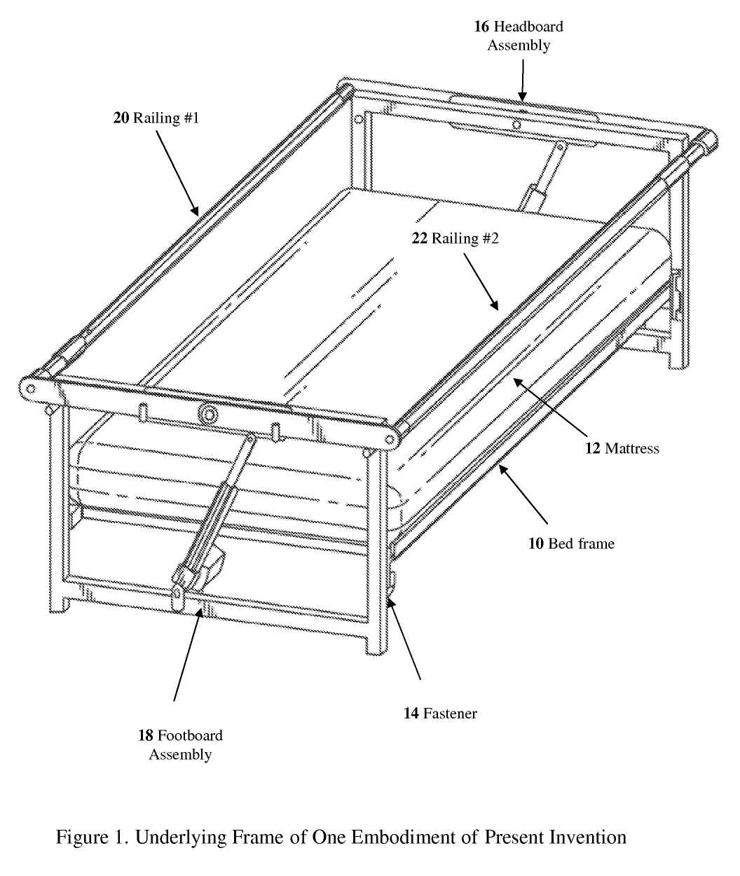

FIG. 1 is a perspective view of one embodiment of the underlying frame of the present invention. In this embodiment, the present invention connects to the bed frame 10 and mattress 12 of a bed by fasteners 14; though only one fastener 14 is pictured in FIG. 1, such a fastener may be employed at each corner of the bed frame 10. The headboard, footboard and railings of a bed may be removed and replaced by a headboard assembly 16, a footboard assembly 18 and two railings 20 and 22, respectively. In some embodiments, only the headboard and footboard of a bed are replaced by the headboard assembly 16 and footboard assembly 18, respectively; the railings 20 and 22 are added to the bed as a second set of railings.

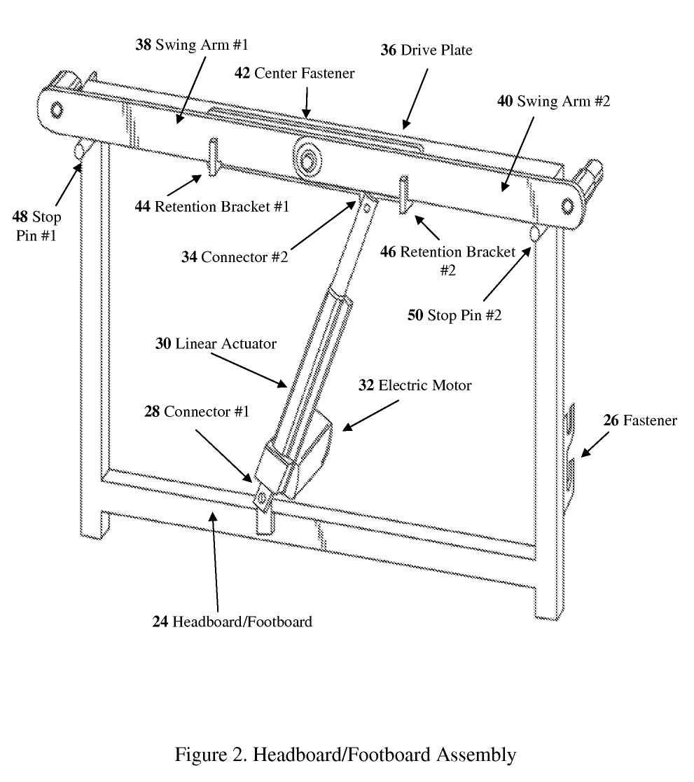

In typical embodiments, the headboard assembly and footboard assembly may be identical and work in tandem to rotate a person in bed. FIG. 2 illustrates a typical embodiment of the headboard assembly or footboard assembly of the present invention. The headboard or footboard 24 connects to a bed frame and mattress by at least one fastener 26. Optimum embodiments use one fastener 26 at each corner of a bed frame, so a headboard assembly and a footboard assembly are each fastened to a bed frame by two fasteners. The bottom of the headboard or footboard 24 contains a first connector 28 (such as a nut/bolt combination) that connects the headboard or footboard 24 to one end of a linear actuator 30 and to an electric motor 32. The electric motor 32 is also connected to the linear actuator 30. The linear actuator 30 is in a middle or neutral position when a person is lying totally flat (or horizontal) in a bed. The other end of the linear actuator 30 attaches to both the top of the headboard or footboard 24 by a second connector 34 (such as a nut/bolt combination) and to a drive plate 36 by a third connector (unseen in FIG. 2). The drive plate 36 also connects to two swing arms 38 and 40 by a center fastener 42 (such as a mechanical pin). The drive plate 36 creates a linkage that allows both swing arms 38 and 40 to be lifted in turn by a single linear actuator 30, instead of requiring a separate linear actuator for each swing arm. In some embodiments, the electric motor 32 may be replaced by a mechanical system (such as a hydraulic or a pneumatic system) that may move the linear actuator 30 by mechanical (i.e., non-electrical) means.

Each swing arm 38 and 40 is connected to a railing as shown in FIG. 1 and has both a retention bracket 44 and 46 to keep it in place and a stop pin 48 and 50. The stop pins 48 and 50 mark the maximum distance that the swing arms 38 and 40 can move and, thus, the maximum angle through which a railing can be rotated. Research has shown that the maximum angle of rotation of a railing should be about 30° with respect to the horizontal; smaller angles of rotation do not move a person enough to prevent and treat bedsores, while larger angles of rotation also cause a person to slide horizontally within a bed, which may be undesirable in some cases.

In typical embodiments, the electric motors in the headboard assembly and footboard assembly may be simultaneously activated. Each electric motor 32 drives a pin that pushes or pulls the drive plate 36. This causes the linear actuator 30 to extend or contract from its middle position. Extension of the linear actuator 30 causes the drive plate 36 to rotate in one direction with respect to the center fastener 42. This causes the swing arm 38 or 40 on one side of a bed to rise. When the corresponding swing arms 38 or 40 are simultaneously raised by both a headboard assembly and a footboard assembly, a railing is raised, thus rotating a person in bed in the opposite direction (i.e., if both swing arms to the person's right rise, the person will be rotated to the left). The swing arms on the other side of the bed may not rise because they are prevented from doing so by their stop pins 48 or 50. In some embodiments, the railing not being rotated by the swing arms 38 or 40 may be adjusted slightly upward during rotation to keep a person in bed from feeling as if he will fall out of the bed and onto the floor; after rotation, this railing may either be returned to its flat position or kept in a slightly raised position. Once the linear actuator 30 is fully extended, the electric motor 32 stops and the person in bed remains in the new (rotated) position. The linear actuators 30 in the headboard assembly and footboard assembly remain fully extended to keep a person in the new rotated position.

When the electric motor 32 is activated again, the linear actuator 30 contracts and returns to its middle position, causing the drive plate 36 to rotate in the opposite direction with respect to the center fastener 42 and the risen swing arms 38 or 40 to return to a flat position. At this point, a person in bed is supine (or unrotated). The next activation of the electric motor 32 causes the linear actuator 30 to fully contract, causing the drive plate 36 to rotate with respect to the center fastener 42 and the swing arms 38 or 40 on the other side of the bed to rise. When the linear actuator 30 is fully contracted, the other railing is raised and the person in bed is now in a new rotated position. The linear actuators 30 in the headboard assembly and the footboard assembly remain fully contracted to keep a person in the new rotated position. A fourth activation of the electric motor 32 returns the linear actuator 30 to its middle position and the person in bed to a supine (or unrotated) position. Electric power to the present invention (whether or not an embodiment uses the electric motor 32) may be automatically turned off for safety reasons if either the head of the bed or the foot of the bed is not totally flat (horizontal); after a rotation has been performed, the head and foot of the bed may be adjusted as desired.

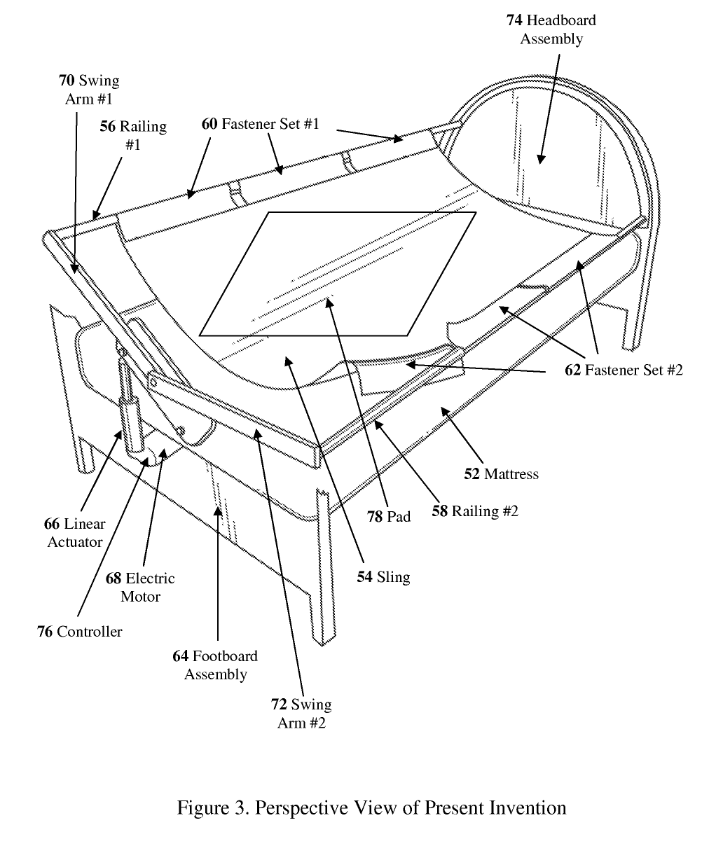

FIG. 3 is a perspective view of one embodiment of the present invention and illustrates how the present invention may rotate a person in bed while keeping an underlying bed frame (not shown) and a mattress 52 on top of the bed frame stationary. As illustrated in FIGS. 1 and 2, the present invention is attached to a bed frame by at least one fastener.

A sling 54 is connected along each vertical side of a bed to railings 56 and 58 by fastener sets 60 and 62. The fastener sets 60 and 62 may be made of Velcro. In typical embodiments, the sling 54 is made of material soft enough to feel comfortable to a person's skin and strong enough to support a person's weight (such as cotton). The sling 54 should not wrinkle or slide when fastened to railings 56 and 58 by fastener sets 60 and 62. The sling 54 may allow as much air circulation under the person in bed as possible, may be detachable from the rest of the present invention, may be washable, may be adjustable to make a person in bed more comfortable, may contain more than one layer of material, and may contain more than one pie ce. The sling 54 is supported by the fastener sets 60 and 62 and acts as a sort of cradle above the mattress 52; in some embodiments, the vertical middle of the sling 54 may brush the top of the mattress 52, with or without a person in bed.

As shown in FIG. 3, the footboard assembly 64 contains a linear actuator 66, an electric motor 68 and two swing arms 70 and 72 connected to corresponding ends of the railings 56 and 58. The headboard assembly 74 is identical to the footboard assembly 64. The headboard assembly 74, the footboard assembly 64 and the railings 56 and 58 are typically made of a metal, a metallic compound (such as steel) or a composite material that can be attached by mechanical fasteners to a bed frame and support the weight of a person in a bed. The headboard assembly 74 connects to a bed frame under the mattress 52.

The linear actuators 66 in the headboard assembly 74 and footboard assembly 64 are in a middle or neutral position when the person to be rotated is totally supine in bed. When the electric motors 68 in the headboard assembly 74 and footboard assembly 64 are activated, the linear actuators 66 in the headboard assembly 74 and footboard assembly 64 both extend from their middle position. Extension of the linear actuators 66 causes the corresponding swing arms 70 or 72 on one side of the bed to rise, thus raising the railing 56 or 58 connected to the swing arms 70 or 72. As the railing 56 or 58 rises, the side of the sling 54 rises that is fastened to the railing 56 or 58. This causes the corresponding side of the person in the sling 54 to slowly rise, so that the person is rotated from a totally supine position into a non-supine position. The railing 56 or 58 attached to the other side of the sling 54 may not move or may move only slightly to help keep a person safely in bed. Once the linear actuators 66 are fully extended, a person remains in the new (rotated) position in bed.

With a person in a rotated position in bed, the electric motors 68 may be activated again. The linear actuators 66 return to their middle positions, causing the railing 56 or 58 and sling 54 to return to their unrotated positions. At this point, the person is lying supine in bed. The next activation of the electric motors 68 causes the linear actuators 66 to fully contract, so that the swing arms 70 or 72 attached to the other railing 56 or 58 (and the corresponding side of the sling 54) to rise. When the linear actuators 66 are fully contracted, the other railing 56 or 58 is raised and a person remains in a different non-supine position. A fourth activation of the electric motors 68 returns the linear actuators 66 to their middle positions, the sling 54 and railings 56 and 58 to an unrotated position, and the person in bed to a supine position. The present invention may also allow a person attached to medical equipment (tubes, IV poles, catheters, etc.) to be rotated in bed without disturbing the medical equipment. In some embodiments, another person (such as a nurse in a health-care facility) may be required to observe that medical equipment is not obstructed at any point during a rotation.

Some embodiments of the present invention may include a second set of side railings, parallel to (and in addition to) those pictured in 56 and 58. This second set of side railings may be the original side railings of a bed and may remain attached to a bed frame even after the headboard assembly and footboard assembly (shown in FIG. 2) have replaced the original headboard and footboard of a bed. This second set of side railings may be either closer to or farther away from the railings 56 and 58 and may be attached to a bed frame and immovable, thus helping to prevent a person from falling out of bed during a rotation. When this second set of side railings is used, the railings 56 and 58 may remain connected to (and rotated by) the swing arms 70 and 72. In other embodiments, this second set of side railings may be connected to (and rotated by) the swing arms 70 and 72; in these embodiments, the railings 56 and 58 may serve to prevent a person from falling out of bed during a rotation.

The present invention may have its rotation controlled by a controller 76, such as a programmable logic controller, The controller 76 may be electrical and/or electronic in nature, may be connected to the electric motor 68, and may set an internal or external timer (not shown in FIG. 3) to govern the time of day a rotation takes place, the number of times in a day that a rotation takes place, and/or the time period that must pass before another rotation takes place. Some embodiments may include the timer as part of a computer software or firmware system. In some embodiments, the present invention may also be controlled by at least one mechanical switch that may be connected to the electric motor 68; when the mechanical switch is manually set to a certain position, a person in bed may undergo rotation or be prevented from rotating. In some embodiments, a timepiece (such as a wristwatch or a clock) may be used to keep track of a rotation schedule; when a person should be rotated ac cording to this schedule, the controller 76 may be activated or a mechanical switch may be set to begin the rotation.

Further embodiments may include a pad 78 placed between the sling 54 and the body of the person in bed. The pad may be detachable from the rest of the present invention, may be washable, may be adjustable to make a person in bed more comfortable, may contain more than one layer of material, may contain more than one piece, may have a disposable outer layer (in case a person in bed soils it), and may contain at least one fastener to fasten the pad to a person and/or to a bed.

The foregoing description of the invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention, except insofar as limited by the prior art.

What is claimed is:

1. A device that attaches to a bed frame by at least one fastener and allows rotation of a person from side to side in a bed without human assistance, comprising:
a headboard assembly;
a footboard assembly;
a set of railings;
an adjustable sling containing at least one layer of washable material that is detachable from said device, attaches by a set of fasteners to said set of railings, supports the weight of said person, and moves while fastened to said set of railings to create said rotation of said person; and,
a controller that controls the movement of said device.

2. The device of claim 1 wherein said device attaches to a standard twin-size bed frame or standard hospital bed frame by replacing a headboard and a footboard of said standard twin-size bed frame or said standard hospital bed frame with said device.

3. The device of claim 1 wherein said device attaches to a standard twin-size bed frame or standard hospital bed frame by replacing a headboard, a footboard and at least one set of railings of said standard twin-size bed frame or said standard hospital bed frame with said device.

4. The device of claim 1 wherein said headboard assembly, said footboard assembly and said set of railings are each made of metal, of a metallic compound (such as steel), or of a composite material.

5. The device of claim 1 wherein said headboard assembly comprises:
a headboard;
a linear actuator;
an electro-mechanical apparatus that controls said linear actuator;
two swing arms that connect to and control the movement of said set of railings; and,
a drive plate that moves said swing arms and is moved by said linear actuator.

6. The device of claim 5 wherein said electro-mechanical apparatus is an electric motor.

7. The device of claim 1 wherein said footboard assembly comprises:
a footboard;
a linear actuator;
an electro-mechanical apparatus that controls said linear actuator;
two swing arms that connect to and control the movement of said set of railings; and,
a drive plate that moves said swing arms and is moved by said linear actuator.

8. The device of claim 7 wherein said electro-mechanical apparatus is an electric motor.

9. The device of claim 1 wherein said adjustable sling is made of cotton.

10. The device of claim 1 wherein said set of fasteners is made of Velcro.

11. The device of claim 1 wherein said controller is a programmable logic controller or at least one electro-mechanical switch.

12. The device of claim 1 further comprising an adjustable pressure-relieving pad containing at least one layer of absorbent material that fits between said person in said bed and said adjustable sling.

13. The device of claim 12 wherein said adjustable pressure-relieving pad is adjusted by use of at least one fastener that allows said adjustable pressure-relieving pad to be attached to said adjustable sling.

14. A method of rotating a person from side to side in a bed at regular intervals without human assistance, comprising:
removing a footboard and a headboard of a standard twin-size bed frame or standard hospital bed frame;
attaching a device to said standard twin-size bed frame or standard hospital bed frame by at least one fastener that can rotate said person without human assistance and without disturbing any medical equipment to which said person may be attached; and,
activating said device.

15. A method of rotating a person from side to side in a bed at regular intervals without human assistance, comprising:
removing a footboard, a headboard and at least one set of railings from a standard twin-size bed frame or standard hospital bed frame;
attaching a device to said standard twin-size bed frame or standard hospital bed frame by at least one fastener that can rotate said person without human assistance and without disturbing any medical equipment to which said person may be attached; and,
activating said device.

16. The method of claim 15, wherein said device comprises:
a headboard assembly;
a footboard assembly;
a set of railings;
an adjustable sling made of at least one layer of material that is detachable from said device, attaches by at least one fastener to said railings, supports the weight of said person, and moves while fastened to said railings to create said rotation of said person; and,
a controller that controls the movement of said device.

17. The method of claim 15 wherein said headboard assembly comprises:
a headboard;
a linear actuator;
an electro-mechanical apparatus that controls said linear actuator;
two swing arms that connect to and control the movement of said set of railings; and,
a drive plate that moves said swing arms and is moved by said linear actuator.

18. The method of claim 15 wherein said footboard assembly comprises:
a footboard;
a linear actuator;
an electro-mechanical apparatus that controls said linear actuator;
two swing arms that connect to and control the movement of said movable railings; and,
a drive plate that moves said swing arms and is moved by said linear actuator.

19. The method of claim 15, wherein said controller is a programmable logic controller or at least one electro-mechanical switch.

20. The method of claim 15, wherein said device further comprises an adjustable pressure-relieving pad that fits between said person in said bed and said adjustable sling.
